(19) United States
(12) Patent Application Publication
(10) Pub. No.: US 2011/0220029 A1
(43) Pub. Date: Sep. 15, 2011

(54) WILD BIRD FEEDER

(76) Inventors: Mario A. Olmos, Fort Worth, TX (US); Eric Juergens, Waunakee, WI (US); Charles E. Bain, El Paso, TX (US); Larry Sternal, Bartlett, IL (US)

(21) Appl. No.: 12/851,371

(22) Filed: Aug. 5, 2010

Related U.S. Application Data
(60) Provisional application No. 61/231,435, filed on Aug. 5, 2009.

(51) Int. Cl. A01K 39/04; A01K 39/00

(52) U.S. Cl. 119/51.5; 119/52.2; 119/52.1

(57) ABSTRACT

A wild bird feeder configured with perches and seed openings that are positioned to encourage certain sizes and species of birds and/or discourage certain sizes and species of birds. A wild bird feeder including a watering station and a feeding station. A wild bird feeder with a seed holder and a plurality of feeding stations vertically spaced apart on the seed holder. A diffuser mounted within the seed holder to define a seed collection point corresponding to at least one of the feeding stations.

### CROSS-REFERENCE TO RELATED APPLICATION

The present application claims priority to U.S. Provisional Application Ser. No. 61/231,435, filed on Aug. 5, 2010, the disclosure of which is incorporated herein by reference.

### BACKGROUND

The feeding and attraction of wild birds has been a hobby of people in many years in many different countries. Over this time, these same people have struggled to attract the more desirable of the wild birds while discouraging the less desirable. For example, a person may wish to attract more colorful birds or birds having a particular call, while simultaneously wishing to keep nuisance birds away from the same feeder. Unfortunately, many of these desirable and undesirable birds live in the same geographic area and are drawn to the same feeders by the availability of food.

It is desirable that wild bird feeders be improved to suit and encourage the visitation for feeding of the more desirable wild bird species. It is also desirable that wild bird feeders be improved to be less comfortable and discourage the visitation of less desirable wild bird species. Preferably, a single feeder design or designs can accommodate both of these desirable goals.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a side view of a wild bird feeder according to the present disclosure.

FIG. 2 is an end view of the wild bird feeder of FIG. 1, with a suet cage removed from end of the feeder.

FIG. 3 is a side view of a second embodiment of a wild bird feeder according to the present disclosure.

FIG. 4 is an upper perspective exploded view of a modular portion of the wild bird feeder of FIG. 3.

FIG. 5 is a second upper perspective exploded view of the modular portion of FIG. 4.

FIG. 6 is a lower perspective exploded view of the modular portion of FIG. 3.

FIG. 7 is a second lower perspective view of the modular portion of FIG. 5.

FIG. 8 is a first side view of a third alternative embodiment of a wild bird feeder according to the present disclosure.

FIG. 9 is a second side view of the wild bird feeder of FIG. 8.

FIG. 10 is a perspective view of one of the feeding stations of the wild bird feeder of FIG. 8.

FIG. 11 is a perspective exploded view of the feeding station of FIG. 10.

FIG. 12 is a top cross-sectional view of the feeding station of FIG. 10.

FIG. 13 is a side cross-sectional view of the feeding station of FIG. 10.

FIG. 14 is a front view of the feeding station of FIG. 10.

FIG. 15 is a side view of the feeding station of FIG. 10.

FIG. 16 is a first side of a fourth embodiment of a wild bird feeder according to the present disclosure.

FIG. 17 is a second side view of the wild bird feeder of FIG. 16.

FIG. 18 is a perspective view of a fifth embodiment of a wild bird feeder according to the present disclosure.

FIG. 19 is a perspective view of a diffuser or baffle for use within tube feeders according to the present disclosure.

FIG. 20 is a perspective view of the diffuser of FIG. 19 shown with a different feeding station.

FIG. 21 is an alternative embodiment of a diffuser for use with a tube feeder according to the present disclosure.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

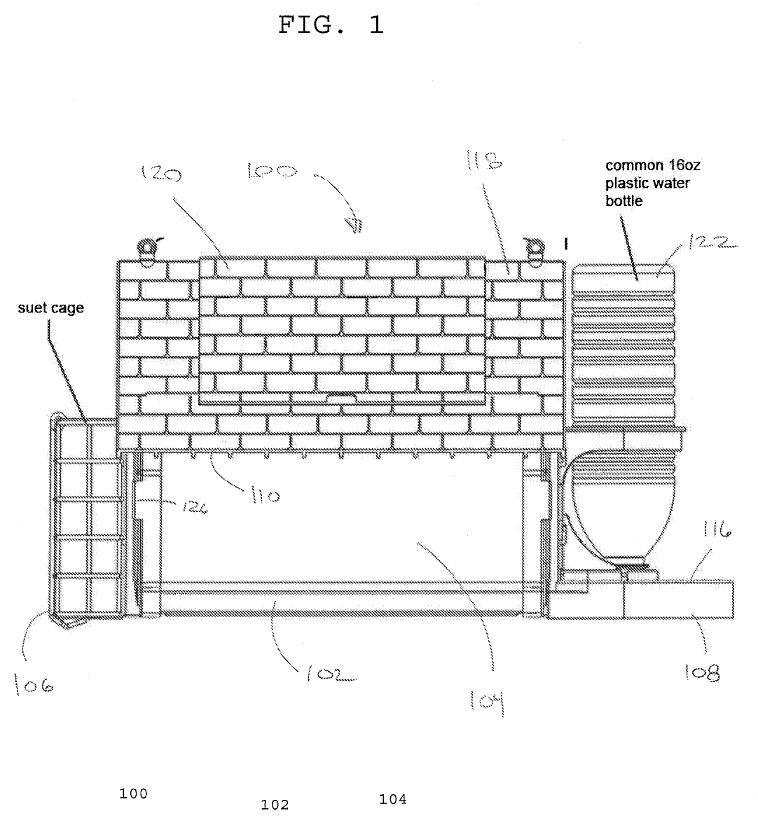

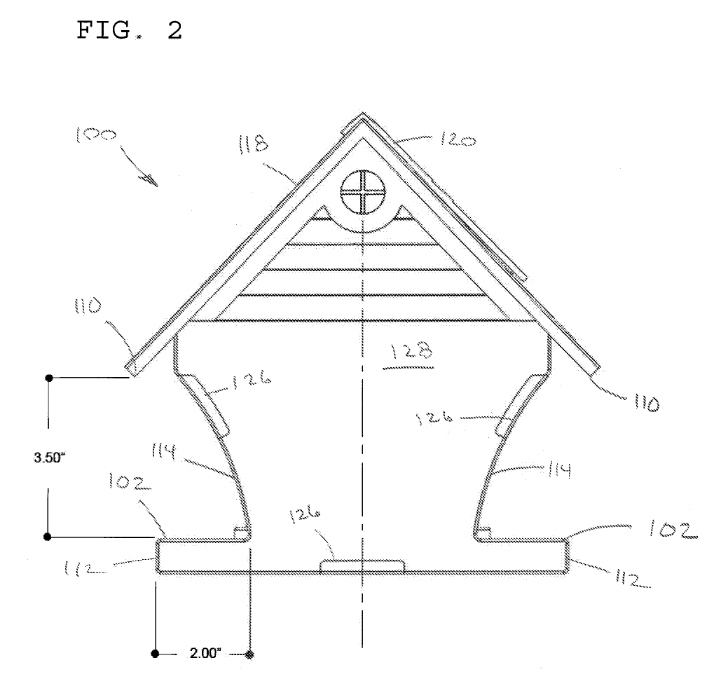

FIGS. 1 and 2 illustrate a wild bird feeder 100 according to the present disclosure that is configured to encourage the visitation of more desirable wild birds species and discourage the visitation of less desirable wild species. A wild bird's diet may preferably have three principal components to ensure good health: seed, fat and water. Feeder 100 provides at least two and preferably all three of these elements and may be configured to flexibly present those elements as needed in a particular feeding environment.

Feeder 100 may include one of more feeding perches 102 to provide a wild bird with access to seeds. A hopper 104 may be positioned to continually deliver seeds to these perches as the original seed is eaten or removed from the perches. An opening 120 in a roof 118 may provide access into hopper 104 for replenishing the seed within the hopper or allowing the hopper to be cleaned. Perches 102 may be protected by an overhanging roof edge 110 and have a depth providing access to the seed that is under roof edge 110 (see FIG. 2).

The spacing of roof edge 110 above the perch may be selected or sized to be more suited to typically smaller, more desirable wild birds, while being too short to permit comfortable use by typically larger, less desirable wild birds. Feeder 100 may also be configured so that an outer edge 112 of perch 102 is spaced apart from a wall 114 of hopper 104 and wild birds are allowed access to the seed from the hopper within this space. The depth of this spacing may also be selected to make feeder 100 less comfortable for use by larger, less desirable wild birds. The vertical and/or horizontal spacing between outer edge 112 and roof edge 110, as well as the horizontal spacing from outer edge 112 and wall 114 may be selected so that a larger bird may not comfortably sit on the perch and reach the seed.

Preferably, roof edge 110 and outer perch edge 112 will be spaced apart by approximately 3.5 inches or less. Preferably, outer perch edge 112 and hopper wall 114 will be spaced apart by approximately 2 inches. The particular dimensions may be altered based on the size and body characteristics of the particular wild bird or size of wild bird that will preferably be attracted. The dimensions shown and discussed herein are illustrative only and are not intended to limit the scope of the present disclosure. Alternatively, the dimensions may be selected to be ill-suited and uncomfortable for a particular nuisance wild bird or size of nuisance wild birds whose visits are preferably discouraged.

In addition to the physical configuration of the perches allowing access to seed from a central hopper, feeder 100 may be further configured to encourage the visits of wild birds by accumulating multiple diet elements into a single location. On a first end of feeder 100, a suet cage 106 may be mounted to secure a suet cake to the feeder. Suet cage 106 may be configured as a modular element that may be removed or added as desired to feeder 100. At different times of the year or in particular seasons, it may be more beneficial to have the suet cage attached to provide a ready source of fat for the wild birds visiting feeder 100. At other times or seasons, it may not be as desirable to present suet as a food at the feeder and suet cage 106 may be removable during those times. As shown, feeder 100 may include a plurality of tabs 126 along an end 128 of the feeder to permit suet cage 106 mounted to a plate corresponding to the size and shape of the end to be easily attached and removed from the feeder.

On a second opposite end of feeder 100 may be mounted a watering station 108 for providing drinking water to wild birds visiting the feeder. Watering station 108 as shown is configured to receive a common screw top water bottle 122, for example but not limited to a one pint or half liter bottle, within a central opening. Water station 108 is preferable removably attached to feeder 100 and may be removed and inverted to receive the top of the bottle. Once the bottle has been attached, the assembly is positioned as shown on feeder 100 to permit water to flow from the bottle into a water trough 116 of watering station 108 for access by the wild birds. Watering station 108 is preferably removably mounted to feeder 100 to permit easy removal, cleaning, replacement, etc., of the water bottle or the watering station.

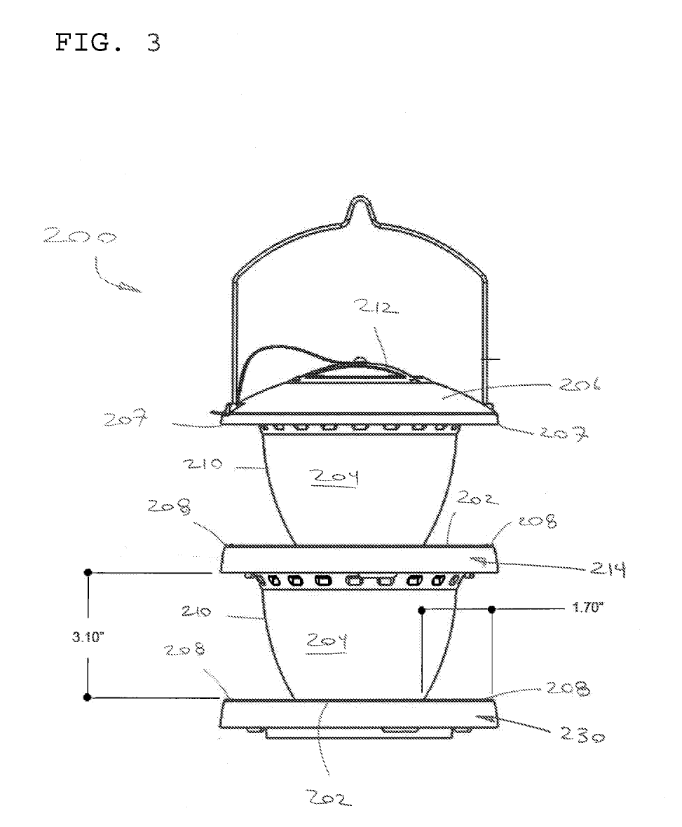

Referring now to FIG. 3, a second embodiment of a wild bird feeder 200 is illustrated to one or more hoppers 204 providing seed to one or more feeding perches 202. A roof 206 with an outer edge 207 may be positioned above the uppermost perch to shelter the seed and to provide a particular spacing above the perch. Similarly, an intermediate element positioned above a lower mounted perch may also provide a similar overhang spacing and geometry, as shown in FIG. 3. This spacing, as discussed above, may be selected to more closely suit the size of wild birds whose presence at the feeder is desired and/or to ill-suit the size of wild birds whose presence is not desired. In addition, as discussed above, an outer perch edge 208 may be spaced apart horizontally from a wall 210 of hopper 204. This outer perch edge 208 to wall 210 spacing may be selected in conjunction with the vertical and horizontal spacing of the outer perch edge and roof edge to further encourage desirable wild bird species and/or discourage undesirable wild bird species.

As shown, spacing between the outer perch edge 208 and inner wall 210 is preferably approximately 1.7 inches. As shown, spacing between roof edge 207 and outer perch edge 208 may preferably be approximately 3.1 inches. The particular dimensions may be altered based on the size and body characteristics of the particular wild bird or size of wild bird that will preferably be attracted. The dimensions shown and discussed herein are illustrative only and are not intended to limit the scope of the present disclosure. Alternatively, the dimensions may be selected to be ill-suited and uncomfortable for a particular nuisance wild bird or size of nuisance wild birds whose visits are preferably discouraged.

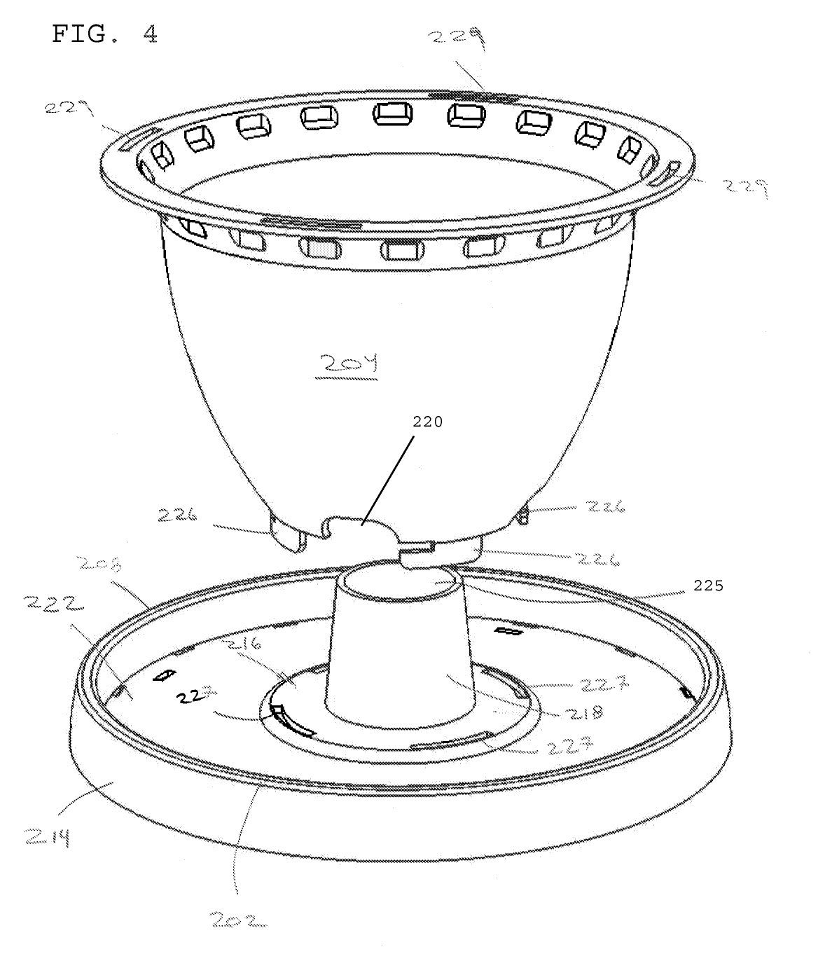

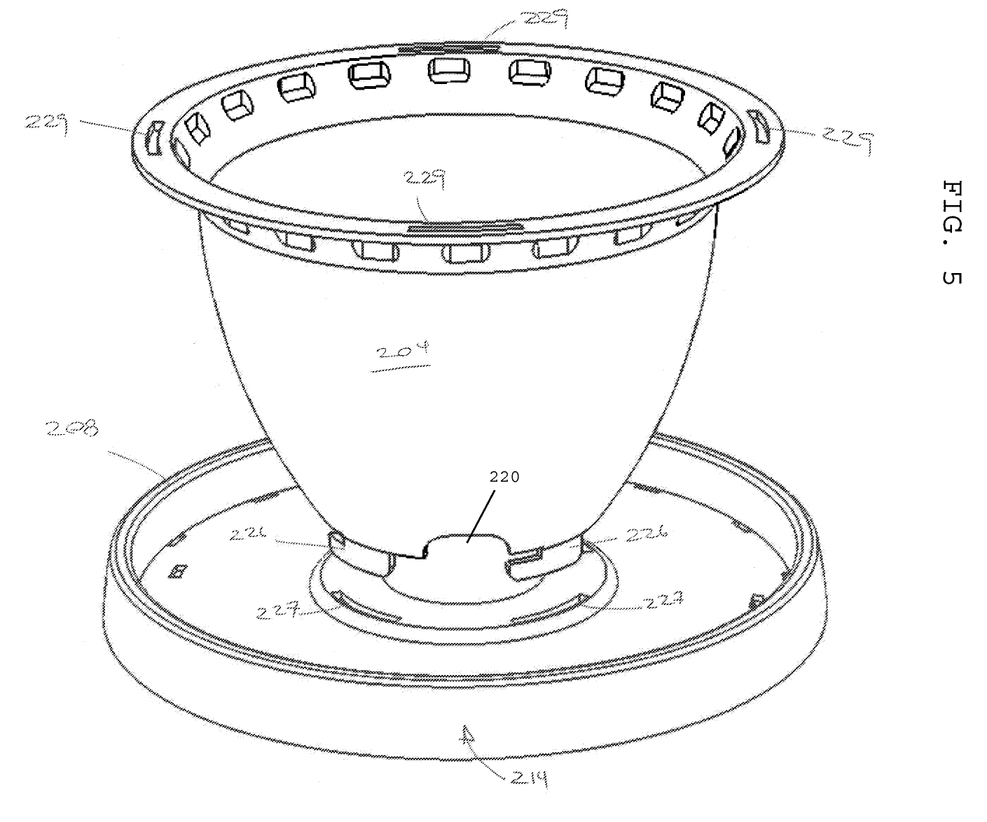

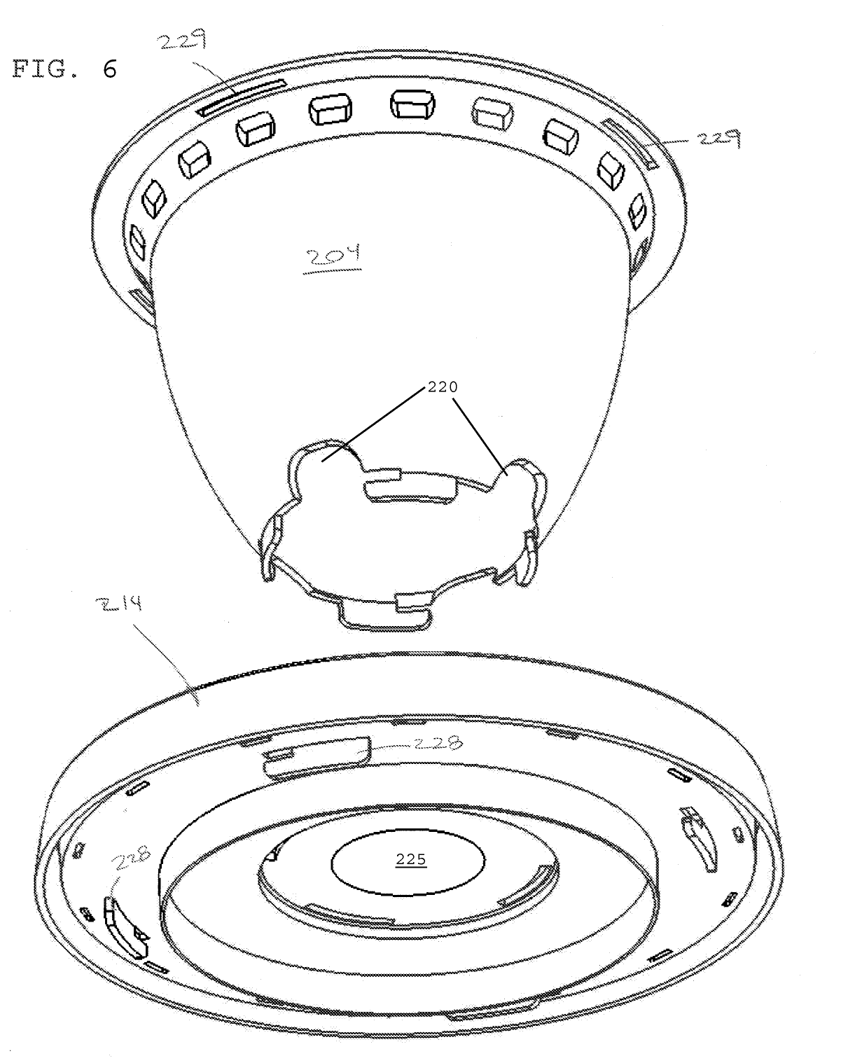

Feeder 200 may also be modular in construction so that additional hoppers 204 and perches 202 may be added while maintaining the desired spacing of the perches and permitting the hoppers to be filled through a single roof opening 212. FIGS. 4 to 7 illustrate that hopper 204 may be a modular element that may be releasably received into a top of a perch platform 214. A central core 216 of platform 214 may provides a raised surface or truncated cone 218 for encouraging seed within the hopper to be distributed through opening 220 and into a feeding trough 222 adjacent perches 202. Cone 218 may include different shapes

Central core 216 may also include a vertical riser 224 that extends upward within hopper 204. Riser 224 is intended to encourage seed to move into trough 222 as birds deplete the seed adjacent the perches. An opening 225 in riser 224 further permits seed that is poured through roof opening 212 to filter down to any lower levels of platforms 214, allowing all levels to be filled through the single roof opening. In addition, riser 224 ensures that seed remains on a particular level of the feeder even if the seed in the level below is depleted. In conventional feeders, it is common for each feeding station or trough to be fed seed from a common column of seed. As the seed within the feeder is depleted, the upper feeding stations or troughs no longer have seed available and birds are forced to use only the lower levels to feed.

As shown, hoppers 204 and platforms 214 (and 230 discussed below) may be connected to each other by a plurality of spaced apart tabs 226 and mating slots 227 along a lower edge of the hopper to form a level of feeder 200. In addition, along a top edge of hopper 204 may be a second plurality of spaced apart tabs 228 that permit additional levels of hopper/platform assemblies to be connected to feeder 200 by mating with corresponding slots 229. A lower platform 230 below the lowest hopper 204 may be configured without an opening in the central core and keep the seed from flowing out of the hopper except through the openings into the trough adjacent the perches.

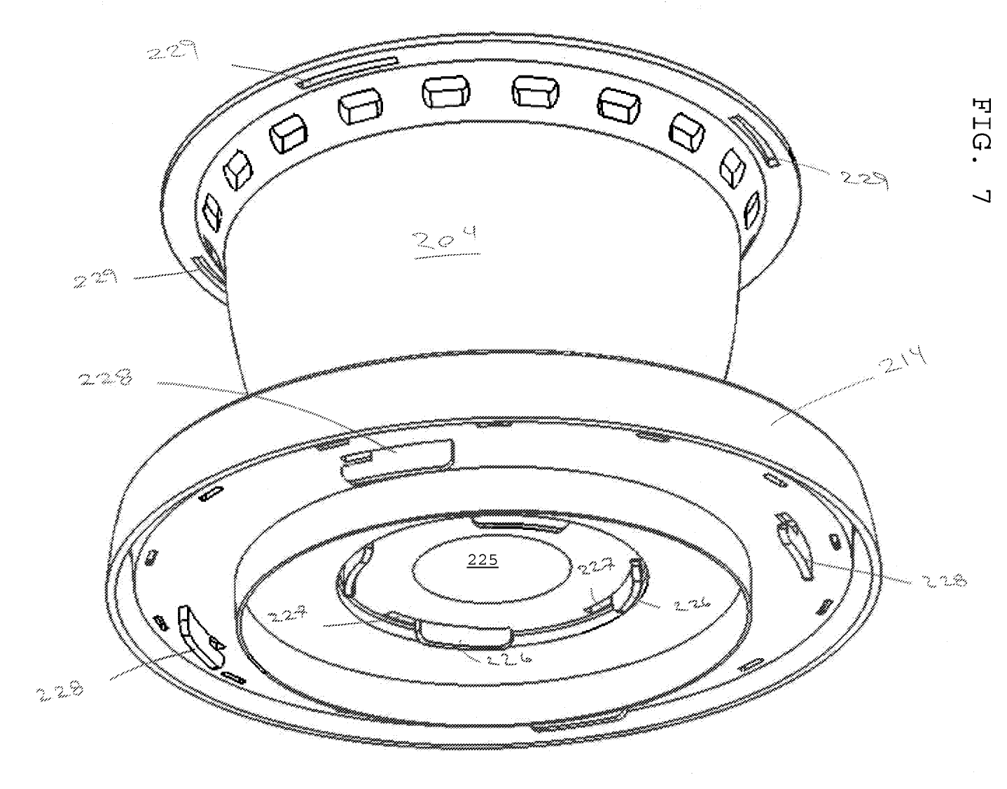

FIGS. 8 and 9 illustrate a third embodiment of a wild bird feeder 300 according to the present disclosure. Feeder 300 may be configured as a tube feeder with a central tube 302 and may have one or a plurality of feeding stations 304 spaced apart along an outer wall 306. Each feeding station 304 may provide an opening into the tube so that a bird can access seed within the tube and may also provide a perch for the bird to sit on while feeding. In addition, within tube 302 may be a plurality baffles 308 that may be configured to hold seed at each of the feeding stations as well as permitting the feeder to be filled through a single open top 310.

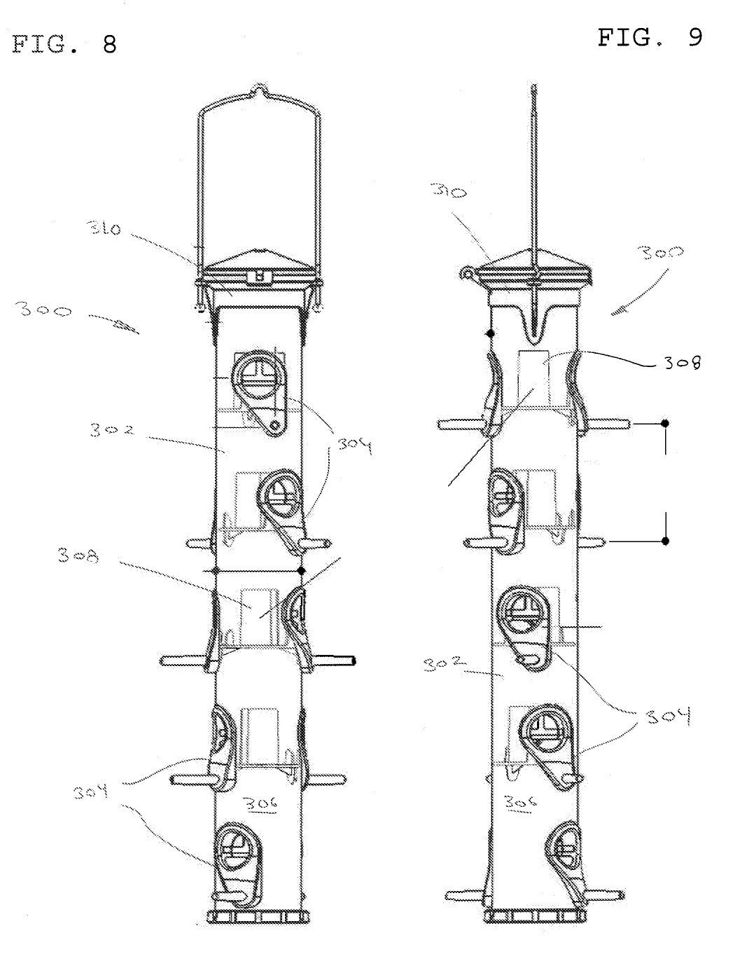

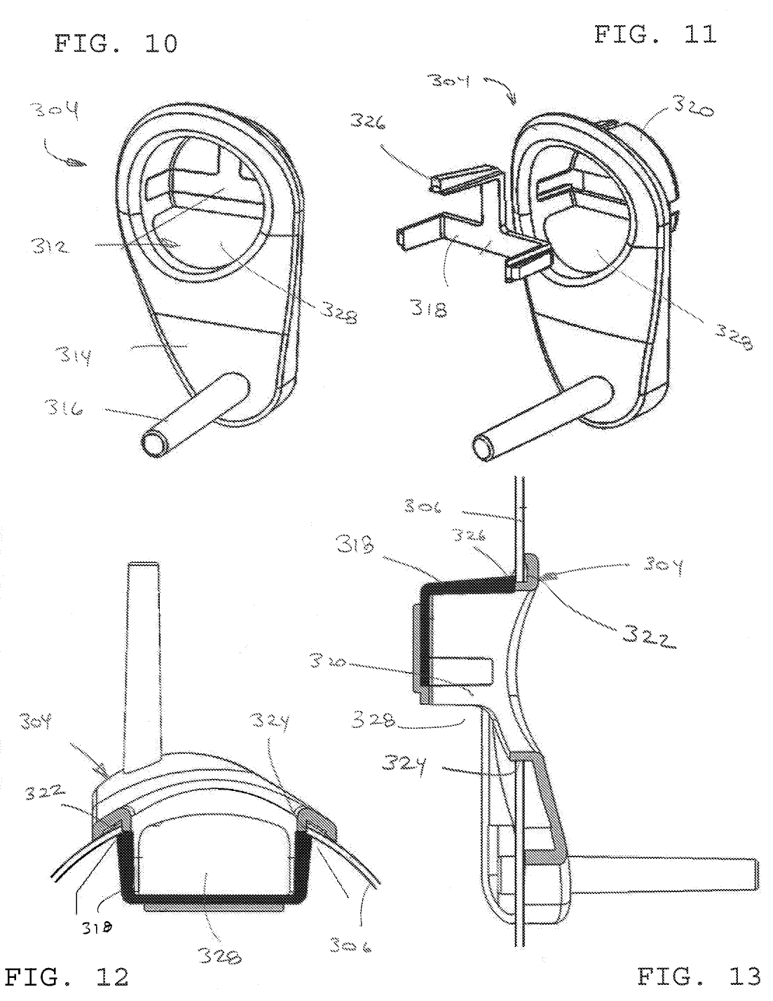

Referring now to FIGS. 10 to 13, feeding station 304 may include a seed opening 312 defined through a plate 314 that is configured to match the shape of outer wall 306. A perch 316 may extend outward from plate 314 beneath and slightly offset from a centerline of opening 312. A clip 318 may be provided that engages a mounting structure 320 on a rear of plate 314. The cooperation of clip 318 and structure 320 permits the feeding station to be mounted within an opening 324 in outer wall 306 of feeder 300. Once structure 320 is inserted within an opening 324, clip 318 may be inserted within opening 312 of feeding station 304. An upper portion or arm 326 of clip 318 may be deflected downward to permit insertion and once in place, as shown in FIGS. 12 and 13, arm 326 snaps back into shape. Arm 326 and plate 314 cooperate to define a space 322 to receive wall 306 about at least a portion of opening 324.

The shape of the rear of plate 314 is configured to hold feeding station 314 in the desired orientation, as shown in the FIGS., by cooperating with the shape of the outer surface of wall 306. Structure 320 may also serve to prevent seed within tube 302 from falling out through opening 312. Birds sitting on perch 316 are still able to access seed within the tube through a lower access opening 328 below structure 320.

As shown in FIGS. 8 and 9, baffles 308 within tube 302 hold seed within the tube at a level beneath access opening 328 that permits birds to reach seed through opening 312.

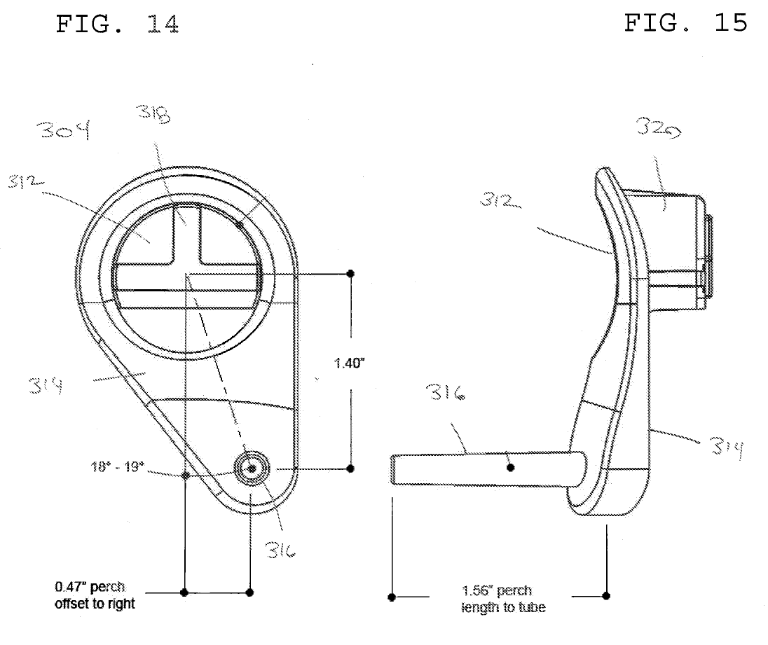

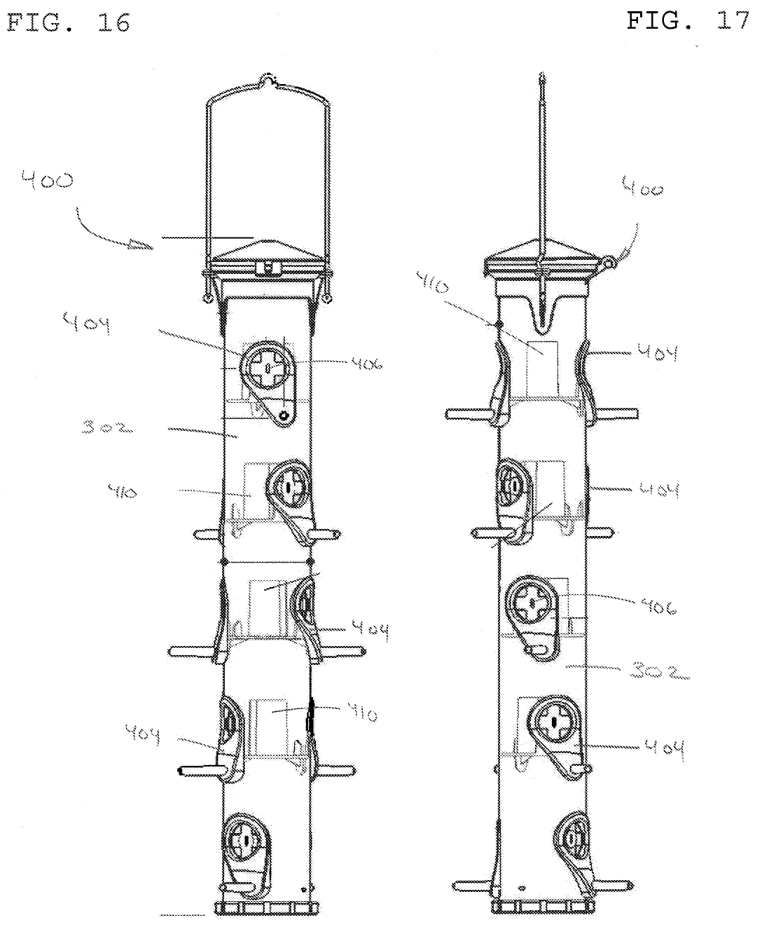

Referring now to FIGS. 14 and 15, feeding station 304 is preferably configured with perch 316 offset to the right of the centerline of opening 312. Previous studies in chickens and pigeons indicated that the right eye was used more that the left for selective pecking. The right eye and its associated left hemisphere are used preferentially when responses have to be considered against alternatives, as in the case of learning, while the left eye and right hemisphere are used when the response must be given without hesitation. This may also apply to other bird species such as songbirds in our backyards. Foraging and selective pecking is more difficult in a tube feeder with straight perches. Birds collect clear information with the fovea centralis in macula of the eye, and this is only possible by turning the head side by side or obtaining the information before placing the head inside the feeder.

Straight perches, that is perches directly underneath the seed access opening may create a blind side, reducing the visual field of the surrounding while birds are feeding from a tube feeder. Angled or offset perches will allow birds to obtain faster information in the fovea centralis of the eye, allowing birds to practice selective pecking and less digging and spilling. Angle perches may also allow birds a much larger field of view while feeding from a tube feeder. This will provide a safer environment while birds are feeding. Also as a results of a better field of view and safer environment birds may stay longer at feeder. It has also been theorized that some species of birds are dominant in one or other eye, and that this dominance is relatively consistent across the species. For example, some bird species may be right eye dominant and others may be left eye dominant.

Feeding station 314 is configured to take advantage of this possible eye dominance and other underlying considerations that may impact the comfort and accuracy of a wild bird visiting a feeder to encourage and discourage particular bird species. With perch 316 offset as shown, a bird on the perch would have their right eye directly adjacent tube 302 when feeding from feeder 300. This may make some less desirable species unable to accurately scan the available seed for a preferred food type or may enable more desirable species to better scan and access a preferred food type at a feeder configured according to the present disclosure. Other theories suggest that this angled or offset configuration might make some species uncomfortable if their dominant eye is unable to easily scan their surroundings for possible predators or other dangers. Alternatively, species with dominant left eyes might have no issues with visiting feeding station 304 as their dominant eye is free to scan while feeding.

Similar to the spacing of perches described above with regard to feeders 100 and 200, the spacing of perch 316 and opening 312 of feeding station 304 may selected to more closely match the body size and morphology of a particular size or species of bird. While other larger or smaller birds may be able to access seed at feeding station 304, it is not as easy or comfortable for them to do so. They may be required to distort their necks into uncomfortable positions that may also compromise their ability to see and respond to threats or dangers. Having a spacing optimized for a particular size or shape of bird may tend to encourage that desired bird and discourage other less desired birds.

It is preferable to have the perch offset approximately one half inch to the right and approximately 1.40 inches below the centerline of opening 312 to attract more desirable birds such as more colorful birds or songbirds. Other less desirable species, such as but not limited to grackles and blackbirds are larger and may have a different dominant eye, rendering feeding station 304 less desirable to those birds. The resulting angle of a line between the perch and the centerline of opening 3123 may form an angle of approximately eighteen to nineteen degrees. Other angles and distances of offset may be selected within the scope of the present disclosure to adapt feeder 300 to attract different species or types of birds. Feeding station 304 may also be adapted to have perch 316 to the left to opening 312 to attract birds having different eye dominance or preference for use of a particular eye for scanning and accessing food.

Vertical spacing between adjacent feeding stations 304 may also impact the species or size of bird attracted to feeder 300. Angular spacing of adjacent feeding stations 304 about outer wall 306 may also be altered to impact the species or size of bird attracted to feeder 300. Perch 316 may be altered in length to more closely adapt the size of feeding station 304 to more closely match the size or species of bird to be attracted.

Feeding station 304 is preferably configured to fit within opening 324 of tube 302 with the perch and opening oriented in the desired fashion. Such flexibility allows a common tube 302 to be used for whichever species of bird is desired to be attracted, with different feeding stations 304 permitting adaption of the feeder as desired.

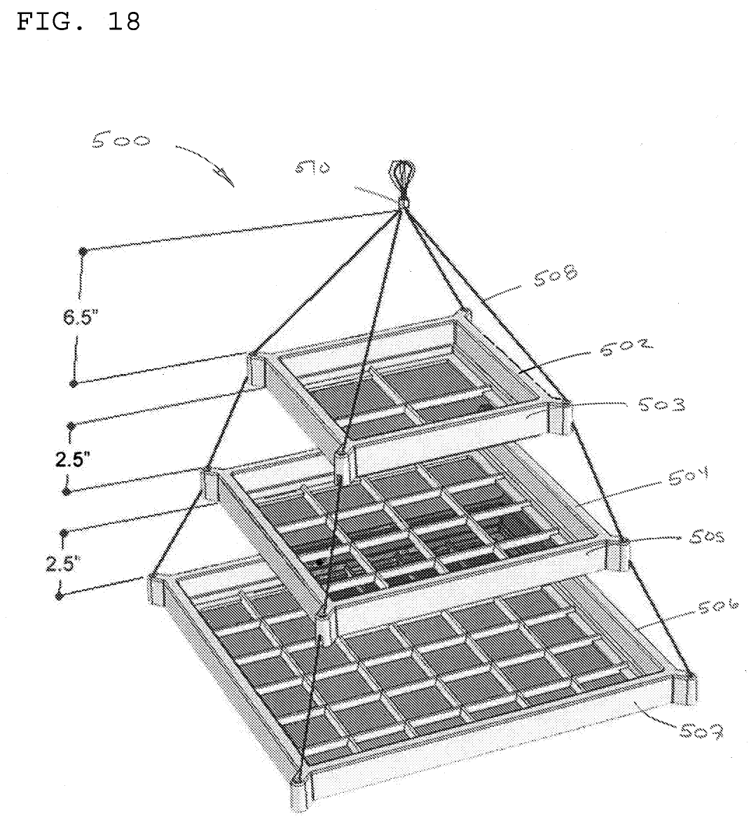

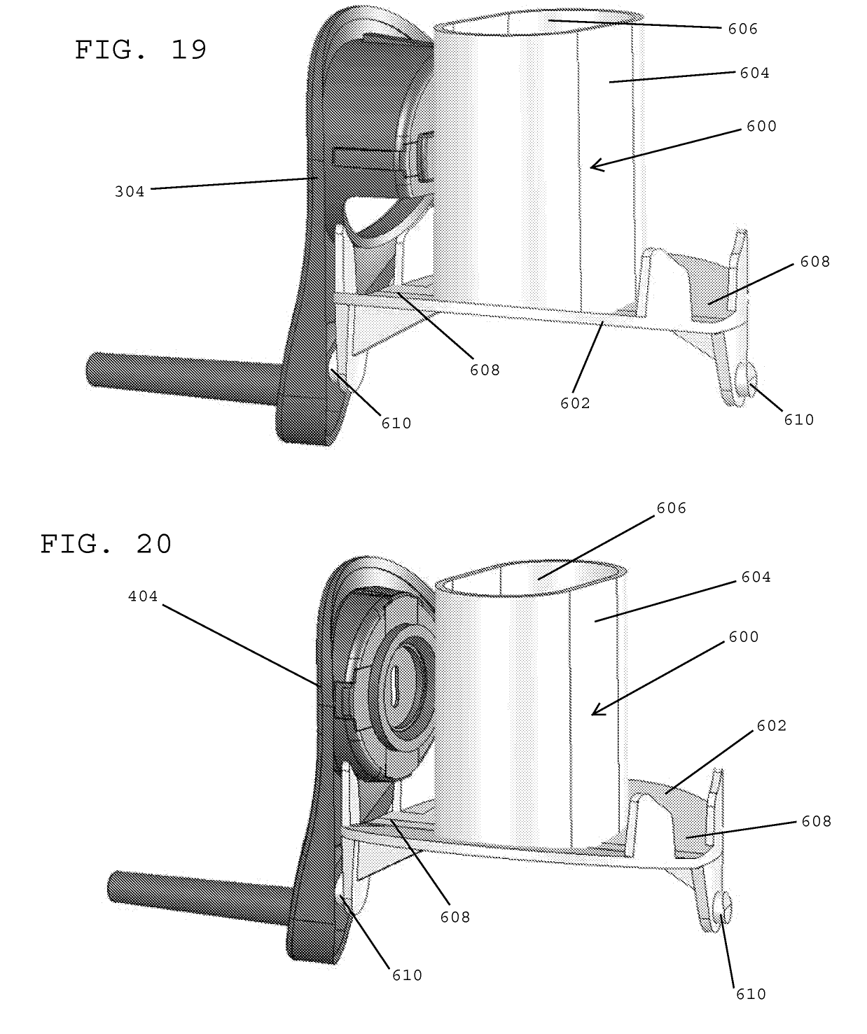

FIGS. 16 and 17 illustrate a further alternative embodiment of a wild bird feeder 400 according to the present disclosure. Feeder 400 is configured similarly to feeder 300 including a tube 302 with a plurality of feeding stations 404 having perches 416 mounted and having corresponding baffles within the tube to hold seed at each station. Feeder 400 is adapted to feed nyjer seed as opposed to larger seeds or grains that may be feed by feeder 300. The smaller seeds to be fed make a smaller access opening 406 in feeding station 404 more desirable as opposed to the much larger access opening 312 of feeding station 304. Different sizes and configurations of access openings in feeding stations according to the present disclosure will permit the feeding stations to be optimized to feed particular size and shape of wild bird food while reducing waste through spillage. As with feeder 300, the orientation and spacing of perches 416 with respect to access openings 406 may be used to adapt feeder 400 to be more comfortable and desirable to particular sizes and species of birds while being less comfortable and less desirable to other sizes and species of birds.

FIG. 18 illustrates a multi-level platform wild bird feeder 500 according to the present disclosure. Feeder 500 may include a plurality of levels, while the three platforms shown are illustrative only. An upper platform 502, an intermediate platform 504 and a lower platform 506 may be held together and spaced apart by a plurality of linkages such as cables 508. While platforms 502, 504 and 506 are shown as squares, it is anticipated that any number of other regular or irregular geometric shapes may be used and that the different platforms may differ in shape from the other platforms.

Cables 508 are preferably anchored to lower platform 506 and extend upward to intermediate platform 504. The spacing between the adjacent platforms my be selected based on the size and characteristics of the birds that are desired to be attracted or desired to be discourage. Vertical and/or horizontal spacing between an outer edge 507 of platform 506 and an outer edge 505 of platform 504 may be used as described above in this disclosure to make the feeder either more comfortably sized or less comfortably sized for particular sizes and/or species of birds. In addition, for smaller birds that may move more by hopping, having seed underneath the overhanging platform may make the seed inaccessible unless the platform spacing is such that it permits hopping into and out from under the overhead platform.

Upper platform 502 may be similarly spaced above the adjacent intermediate platform 504, or above a lower platform 506 for a two level feeder configuration. Above upper level 502, cables 508 may be used to provide a further overhanging structure to deter birds that are larger or which need to hop for moving about the platform. Cables 508 may be connected at a junction 510 above platform 502. In addition to providing a potential mounting or hanging point, cables 508 angling over upper platform 502 may also constrain how larger birds are able to access the seed on this platform.

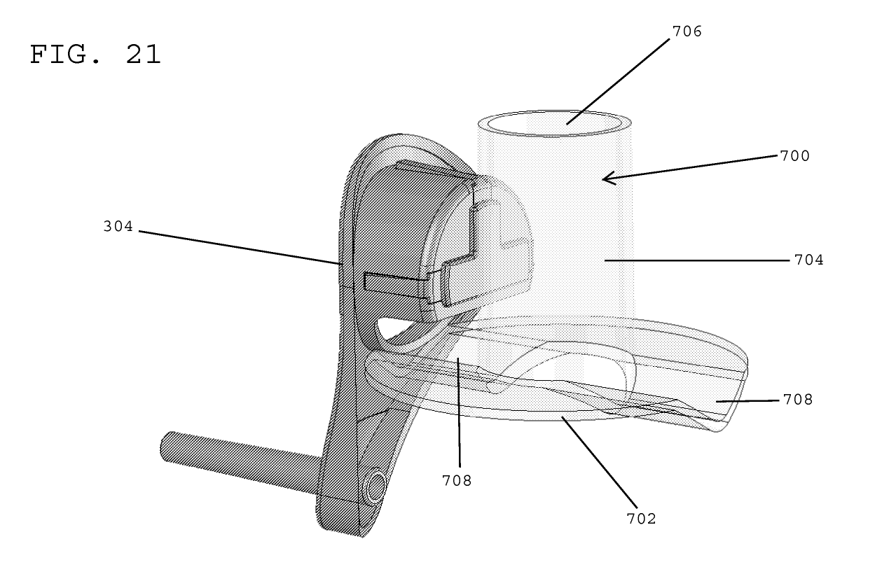

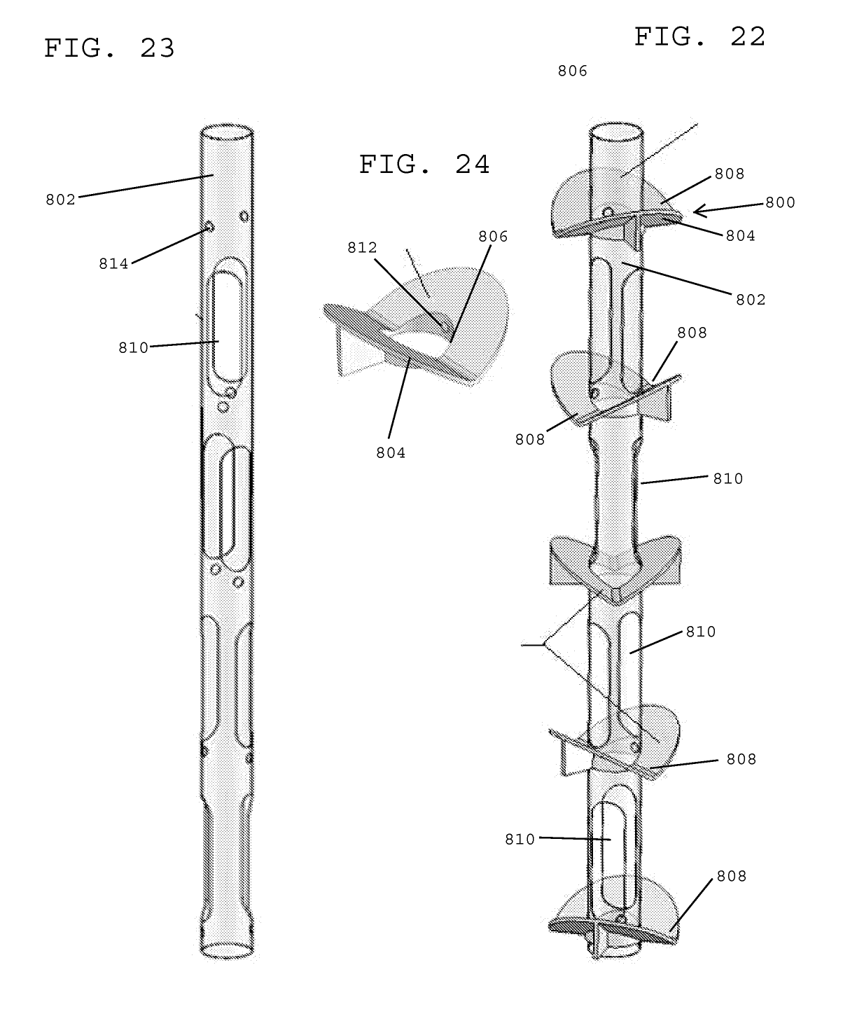

FIGS. 19 and 20 illustrate a baffle or diffuser 600 for use within a tube feeder that includes a plurality of feeding stations. Diffuser 600 is shown adjacent a feeding station 304 and 404 for sample purposes only and it is not intended that the diffuser be limited to use in conjunction feeding stations according to the present disclosure. Diffuser 60 may be used with any tube feeder having a plurality of levels of feeding stations.

Diffuser 600 may includes a lower plate 602 and a central riser 604 with an opening 606 defined through the rider and plate permitting seed to pass through the diffuser to lower levels within the feeder. Each plate 602 defines at least one seed collection point 608, preferably located adjacent a feeding station to accumulate seed within the tube at a position where a bird may access the seed through the station. Preferably, plate 602 includes geometry or surfaces that are inclined to urge seed into collection point 608. In addition, one or more mounting pin 610 may be included to engage the tube feeder to secure the diffuser at a desired location or level within the feeder. As shown, diffuser 600 is configured to provide a seed collection point 608 to two oppositely mounted feeding stations.

As described above, diffuser 600 will also serve to hold seed at different higher levels of a feeder even when the seed at lower levels has been depleted. In conventional wild bird feeders, when the seed level within the feeder begin to drop, the higher feeding stations no longer have seed available and birds are unable to feed at these stations.

FIG. 21 illustrates an alternative embodiment of a diffuser 700 which is similar in function and usage to diffuser 600. Diffuser 700 includes a lower plate 702 defining one or more seed collection points 708. A central riser 704 includes an opening 706 for seed to pass through the riser and the plate.

FIGS. 22 to 24 illustrate a further alternative of a diffuser 800 that includes a central tube 802 configured to extend essentially the full length of a wild bird feeder. A plurality of lower plates 804 may be provided at different levels along tube 802 to define seed collection points corresponding to feeding stations at different levels along the exterior of the feeder. When seed is poured into the feeder it enters tube 802 at the top and beings to fill the feeder from the bottom up. Between each plate 804 is at least one opening 810 in tube 802 that permits seed within the tube to fall into the plates at each level as the feeder is filled. Plates 804 may include one or more buttons or catches 812 within a central opening 806 that may engage mating slots or holes 814 in tube 802 to secure each plate at the desired level to have the collection points 808 located adjacent feeding stations.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A wild bird feeder comprising:
a watering station to provide water for wild birds visiting the feeder; and,
a feeding station.

2. The wild bird feeder of claim 1, further comprising the feeding station is a hopper feeder and the watering station is removably mounted to an end of the hopper feeder.

3. The wild bird feeder of claim 2, further comprising a suet feeder mounted to an opposite end of the hopper feeder from the watering station.

4. The wild bird feeder of claim 1, further comprising the feeding station is a suet feeder.

5. The wild bird feeder of claim 2, further comprising an overhanging roof positioned above a perch of the hopper feeder, the roof spaced vertically above the perch a distance selected to discourage larger nuisance birds from visiting the feeder.

6. A wild bird feeder comprising:
a seed holder having a generally vertical wall;
a feeding station mounted to the seed holder, the feeding station comprising an opening permitting access to seed within the seed holder and a perch mounted below the opening;
wherein the perch is mounted offset laterally from a vertical centerline of the opening and below a horizontal centerline of the opening, the perch further extending generally perpendicularly from the wall of the seed holder.

7. The wild bird feeder of claim 6, further comprising the perch mounted approximately one half inch to the right of the centerline of the opening.

8. The wild bird feeder of claim 7, further comprising the perch mounted approximately 1.4 inches below the horizontal centerline of the opening.

9. The wild bird feeder of claim 6, wherein the wild bird feeder is a tube feeder and further comprising the seed holder is a tube.

10. The wild bird feeder of claim 6, further comprising a plurality of feeding stations mounted to the seed holder.

11. The wild bird feeder of claim 10, further comprising feeding stations that are spaced apart vertically along the wall of the seed holder.

12. The wild bird feeder of claim 6, wherein the feeding station is mounted within an opening in the wall of the seed holder.

13. The wild bird station of claim 12, further comprising the feeding station including a plate and a mounting structure extending through the opening in the wall of the seed holder.

14. The wild bird feeder of claim 13, further comprising a clip passed through the opening of the feeding station and the opening in the wall of the seed holder to engage the mounting structure, the engagement of the clip and the mounting structure securing the feeding station within the opening of the seed holder.

15. A wild bird feeder comprising:
a seed holder having an outer wall;
a plurality of feeding stations vertically separated along the outer wall of the seed holder;
a diffuser mounted within the seed holder corresponding to at least one of the feeding stations, the diffuser including a lower plate extending generally across the seed holder, and a central opening, the lower plate defining a seed collection point adjacent the corresponding feeding station and a vertical riser extending above the vertical plate about the central opening.
